(19) United States
(12) Patent Application Publication
(10) Pub. No.: US 2009/0103404 A1
(43) Pub. Date: Apr. 23, 2009

(54) Optic disk drive power management method for computer system

(76) Inventor: Chai-Chang Chiu, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/976,094

(22) Filed: Oct. 22, 2007

(51) Int. Cl. G11B 5/00

(52) U.S. Cl. 369/47.5

(57) ABSTRACT

Disclosed is an optic disk drive power management method for a computer system, which uses a keyboard controller, together with a system basic input/output system of the computer and a virtual optic-disk driver, to determine the status of the optic disk drive, including connection and removal of the optic disk drive, loading of a disk to the optic disk drive, and actuation of an eject button, and controls supply of power to the optic disk drive accordingly. Also, the system basic input/output system is employed to inform the virtual optic-disk driver to display an identifiable color (colored or gray) or figure representing the icon of the optic disk drive, thereby illustrating the status of the optic disk drive.

### FIELD OF THE INVENTION

The present invention generally relates to a power saving technology for computer systems, and in particular to an optic disk drive power management method for controlling the power supplied to an optic disk drive connected to a computer system.

### BACKGROUND OF THE INVENTION

Computer systems today are broadly used in various fields, such as industrial and business applications and other personal requirements. It not only provides effectiveness and efficiency for industrial and business activities but also brings a convenient life style. The use of portable computers and notebook computers made it even more convenient for users. The portable computers and the notebook computers run on power supplied by batteries, which is usually limited. This fact makes power saving a very important subject.

Several kinds of methods have been used to achieve the objective of saving power for portable computers and notebook computers. For example, some operating systems of computers include a sleep control function, and this function automatically puts the computer into a “sleep” mode if the computer has been left unused for a predetermined period of time. Although this function can automatically detect the operation status of a computer, it can only save power when the computer is unused for a certain period of time.

Analysis of the power loading of a computer system indicates that certain peripherals that are associated with the computer consume most of the power. For example, for a portable computer equipped with an optic disk drive, the optic disk drive will be one of the devices that consume the most amount of battery power when the computer is operated with a built-in battery based power source. The optic disk drive still consumes electricity even when it is unused and contains no optic disk therein. Thus, under the situation that the computer system is powered by the built-in battery set, the time period in which the battery can sustain is greatly affected.

In order to achieve the goal of power saving and power management, various technologies have been suggested in prior references. For example, Taiwan Patent No. 267732 discloses a power saving device, which detects the power loading status of a computer system and, based on the detection result, controls the power supplied from a power supply module. The power saving device implements a load detection circuit and a power saving control circuit. The load detection circuit receives a load voltage signal and compares the signal with a reference voltage to generate a control signal. The power saving control circuit receives the control signal and, based on the control signal, carries out power supply control of the power supply module, thereby effecting power saving.

Taiwan Patent No. 255449 discloses an optic disk drive power saving method and device, which detects whether or not the optic disk drive enters a sleep mode to control power supplied to the optic disk drive. The known device comprises a main determination device implemented in the optic disk drive, so that when the optic disk drive enters the sleep mode, the main determination device of the optic disk drive shuts down circuits of the optic disk drive that are still active. The main determination device also functions to respond to a signal received from outside the optic disk drive so that when the signal indicates wake-up of the optic disk drive, the main determination device awakes up the circuits that were shut down.

U.S. Pat. No. 6,957,282 disclosed a device for controlling an optic disk drive via a keyboard controller of a notebook computer. The device is implemented between the keyboard controller and the optic disk drive, comprising an optic disk idle detection link between the keyboard and the optic disk drive. The keyboard controller detects the status of the optic disk drive through the idle detection link and controls the operation of the optic disk drive.

### SUMMARY OF THE INVENTION

Although various power-saving and power-managing technologies for computer systems are available in the prior references, the known technologies are very complicated and troublesome. For example, some of the known methods need to additionally include an electric control circuit or to modify the circuits inside a hard drive in order to realize power saving. None of the technologies mentioned in the prior references takes full advantage of the computer system resources to control the optic disk drive.

Further, even if the known technologies can realize the objective of power management and power saving, they still cannot provide users with full control over the system. For example, an optic disk drive for either a CD or a DVD becomes a standard peripheral for a computer system or a notebook computer. When a user works with a computer, the optic disk drive is often treated as a data storage device for reading/writing data. However, for most of the time of the operation of the computer, the optic disk drive is left unused. Further, when no disk is contained in the optic disk drive, the optic disk drive is also in an idle and unused condition. The optic disk drive still consumes power while it is unused or in the idle condition. Such a situation is just a waste of electricity power for a desktop computer system, but for a notebook computer, this means increased loading to a battery of the notebook computer and this is a major issue.

Analyzing the power loading of all the components of a computer system shows that the optic disk drive is one of the major components that consume greater amounts of power than the other components that make up the computer. Apparently, ignorance of this fact in dealing with the power saving and management issue would lead very limited effect in improving the system performance.

Thus, a primary objective of the present invention is to provide an optic disk drive power saving method for a computer system, which uses components and resources that are already present in the computer system to perform the most effective power saving and management.

Another objective of the present invention is to provide an optic disk drive power management method that can perform power management among different statuses of the optic disk drive, including connection and removal of the optic disk drive, loading of a disk to the optic disk drive, and actuation of an eject button, based on which appropriate power saving controls are performed.

A further objective of the present invention is to provide an optic disk drive power management method that shows to a user the status of the optic disk drive at all times, wherein a virtual optic-disk driver is employs to show a device icon of the optic disk drive with different colors (colored or gray) or figures to indicate the status of the optic disk on the computer system.

To achieve the above objectives, the present invention provides an optic disk drive power management method, which is formulated to overcome the issue of waste of power at the time when the optic disk drive contains no disk and is powered by a battery set by shutting down the power supply to the optic disk drive thereby effectively extending the time period in which the battery set may supply power. The method only turns the power supply back on when the optic disk drive is actually put into operation.

In a preferred embodiment, the present invention uses a keyboard controller, together with a system basic input/output system of a computer and a virtual optic-disk driver, to determine the status of the optic disk drive, including connection and removal of the optic disk drive, loading of a disk to the optic disk drive, and actuation of an eject button, and controls supply of power to the optic disk drive accordingly. Also, the system basic input/output system is employed to inform the virtual optic-disk driver to display an identifiable color (colored or gray) or figure representing the icon of the optic disk drive, thereby illustrating the status of the optic disk drive.

### BRIEF DESCRIPTION OF THE DRAWINGS

The present invention will be apparent to those skilled in the art by reading the following description of the best mode for carrying out the present invention, with reference to the attached drawings, in which:

FIG. 1 is a system block diagram that embodies an optic disk drive power management method in accordance with the present invention;

FIG. 2 is an operation flow chart that shows the operations that is conducted when an optic disk drive is connected to a computer;

FIG. 3 is an operation flow chart that shows the operations that is conducted when the optic disk drive is already connected to the computer; and

FIG. 4 is an operational flow chart that shows the operation that is conducted when the optic disk drive is removed from the computer.

### DETAILED DESCRIPTION OF THE PREFERRED EMBODIMENTS

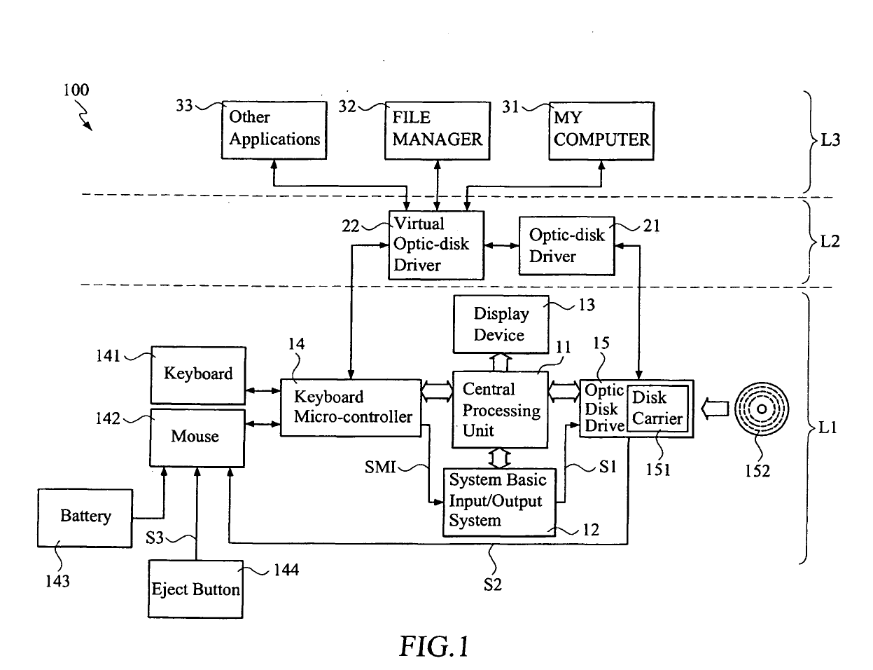

With reference to the drawings and in particular to FIG. 1, which shows a system block diagram that embodies an optic disk drive power management method in accordance with the present invention, a computer system, which is presented in a simplified form and is designated at 100, comprises a central processing unit 11, a system basic input/output system (BIOS) 12, a display device 13, and a keyboard controller 14. The keyboard controller 14 is connected to the central processing unit 11 through a bus and a preset signal port. The keyboard controller 14 and the system basic input/output system 12 are connected by an SMI signal line. A SMI status signal is transferred from the keyboard controller 14 to the system basic input/output system 12 through the SMI signal line.

An optic disk drive 15 is connected to the central processing unit 11 through a bus, such as an IDE interface bus or a USB interface, and a preset signal port. The system basic input/output system 12 transmits a power supply control signal S1 to the optic disk drive 15 through a signal line to determine whether to supply power to the optic disk drive 15. The optic disk drive 15 comprises a disk carrier 151, which selectively carries a disc 152. When an optic disk 152 of a data format matching the optic disk drive 15, such as a CD or a DVD, is inserted into the carrier 151 and the carrier 151 is closed, the computer system 100 reads data from or writes data to the disc 152. In a preferred embodiment of the present invention, an optic disk drive (such as the optic disk drive 15 shown in the drawing), such as a conventional optic storage device for CD or DVD, is taken as an example to illustrate the principle of the present invention for effecting power saving, and it is understood that the present invention can also be applied to power management of other computer peripherals that consume a great amount of electrical power.

The keyboard controller 14 determines whether the optic disk drive 15 is connected to the computer system 100 by checking an optic disk drive standby signal S2. If the optic disk drive 15 qualifies the plug-and-play standards, then the keyboard controller 14 detect the optic disk drive 15 immediately at the time when the optic disk drive 15 is plugged to the computer system 100.

The keyboard controller 14 is connected with a keyboard 141 and/or a computer mouse 142 to serve as an input device of the computer system 100. In a notebook computer, a battery 143 is used to supply power to the computer system 100, and the power supplied from the battery 143 is managed and controlled by the keyboard controller 14.

The keyboard controller 14 is also connected to a disk eject button 144. When a user presses the disk eject button 144, an ejection signal S3 is sent to the keyboard controller 14, and in response thereto, the keyboard controller 14 then controls the operation of the optic disk drive 15 through the system basic input/output system 12 to eject the disk carrier 151. The user can then insert a disc 152 into the disk carrier 151 or take out the disc 152 from the carrier 151.

The arrangement/components mentioned above belong to hardware level L1 of the computer system 100. The current architecture of personal computers also includes other components, such as a system memory, a bridge, a display interface, and a power supply.

The computer system 100 also includes driver level L2, which contains the drivers for each hardware device. For example, the optic disk drive 15 is operated by an optic-disk driver 21. The computer system 100 can read/write data into the disc 152 located in the optic disk drive 15 through the optic-disk driver 21.

Inside the computer system 100 used in the present invention, the driver level L2 comprises a virtual optic-disk driver 22. The virtual optic-disk driver 22 can work with the present invention to control the work process of power management and power saving for the optic disk drive 15.

An operation system level (OS level) L3, which contains system management programs and other applications, is also included in the computer system 100, such as, “MY COMPUTER” 31, “FILE MANAGER” 32 and other applications 33 that will access the optic disk drive, which are included in WINDOWS operating system currently adopted in most of the personal computers.

The virtual optic-disk driver 22 is defined in the driver level. The virtual optic-disk driver 22 is loaded after the operating system of the computer system 100 completes initialization and other necessary device drivers are launched. The virtual optic-disk driver 22 can reside in the system memory of the computer system 100.

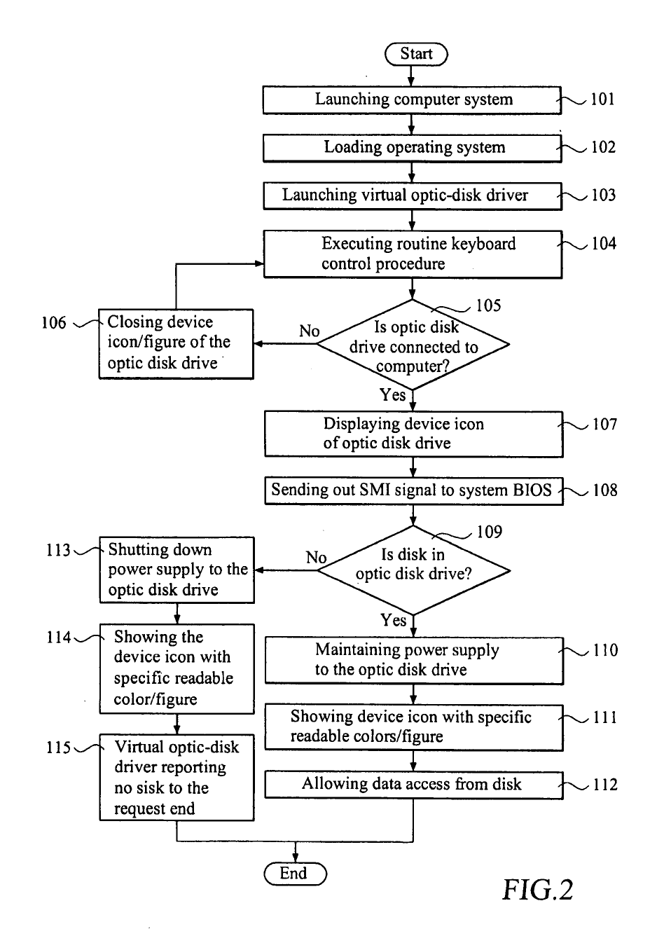

FIGS. 2-4 show flow charts of the method in accordance with the present invention. The method of the present invention will be explained with reference to the computer system 100 illustrated in FIG. 1. Firstly, FIG. 2 shows the control flow in accordance with the present invention at the time when the optic disk drive 15 is connected to the computer 100. When the computer system 100 has been launched (step 101) and the operating system has been loaded (step 102), the virtual optic-disk driver 22 is then launched (step 103). The keyboard controller 14 functions to execute a routine keyboard control procedure (step 104), including for example battery detection, keyboard detection, and switch detection.

At the same time, the keyboard controller 14 checks the status of the optic disk drive 15 to determine whether the optic disk drive 15 is connected to the computer system 100 (step 105). When the keyboard controller 14 detects no optic disk drive, the keyboard controller 14 alerts the virtual optic-disk driver 22 to remove or close the device icon or device figure of the optic disk drive 15 on the display device 13 or other related system management programs, such as “MY COMPUTER” or “FILE MANAGER” (step 106).

When the keyboard controller 14 detects the optic disk driver properly connected, the keyboard controller 14 notifies the virtual optic-disk driver 22 to display the device icon or device figure of the optic disk drive 15 on the display device 13 (step 107) to show that the optic disk device 15 is properly connected to the computer system 100. The keyboard controller 14 at the same time sends out an SMI signal to the system basic input/output system 12, to notify the system basic input/output system 12 that the optic disk drive 15 is connected (step 108).

The system basic input/output system 12 would further check whether the optic disk drive 15 includes a disk (step 109). If yes, the system basic input/output system 12 would not shut down the power supply to the optic disk drive 15 (step 110), and the system basic input/output system 12 alerts the virtual optic-disk driver 22 to show the device icon of the optic disk drive 15 on the display device 13 with a specific readable color (colors) or a specific figure (step 111) to show that a disk 152 is located in the optic disk drive 15 and power is supplied. Under this situation, the computer 100 is allowed to read data from and/or write data to the disk 152 (step 112).

When the system basic input/output system 12 detects that there is no disk 152 in the optic disk drive 15, the system basic input/output system 12 shuts down the power supplied to the optic disk drive within a certain period of time (for example, 30 seconds) (step 113). The system basic input/output system 12 also notifies the virtual optic-disk driver 22 to show the optic disk drive 15 on the display device 13 with a specific readable color (gray) or a specific figure of (step 114) to show that the optic disk drive 15 is connected but no disk is contained, and no power is supplied. When the system management program or applications of the OS level wants to read from the optic disk drive 15, the virtual optic-disk driver 22 will report to the request end (for example “MY COMPUTER” 31, “FILE MANAGER” 32 and other applications 33 that will access the optic disk drive 15) that there is no disk contained in the optic disk drive 15 (step 115). In other words, the virtual optic-disk driver 22 blocks all the access requests from the upper layer(s).

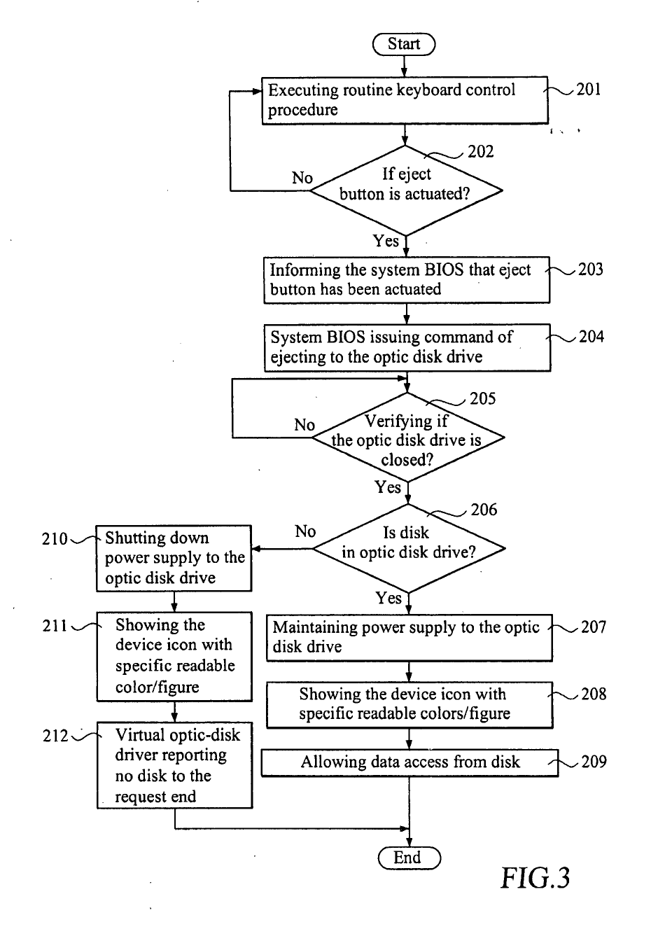

FIG. 3 shows the operation flow of the computer system when the optic disk drive is already connected to the computer. When the keyboard controller 14 executes the routine keyboard control procedure (step 201), if the keyboard controller 14 detects that the eject button 144 of the optic disk drive 15 is actuated (step 202), the keyboard controller 14 will inform the system basic input/output system 12 that the eject button 144 has been actuated (step 203). The system basic input/output system 12 then issues a command of ejecting/opening to the optic disk drive 15 (step 204).

Thereafter, the system basic input/output system 12 checks whether the optic disk drive 15 is properly closed (step 205). If so, the system basic input/output system 12 goes no checking if any disc is inserted into the optic disk drive 15 (step 206). If a disk is inserted, the system basic input/output system 12 maintains power supply to the optic disk drive 15 (step 207), and the system basic input/output system 12 notifies the virtual optic-disk driver 22 to show a specific readable color (colors) or a specific figure of the optic disk drive 15 on the display device 13 (step 208) to indicate that the optic disk drive 15 is connected and a disk 152 is contained, and power is supplied. At this time, the computer system is allowed to access data on the disk 152 (step 209).

When the system basic input/output system 12 detects that there is no disk 152 in the optic disk drive 15, the system basic input/output system 12 shuts down the power supplied to the optic disk drive 15 in a certain period of time (for example 30 seconds) (step 210). The system basic input/output system 12 notifies the virtual optic-disk driver 22 to show a specific readable color (gray) or figure of the optic disk drive 15 on the display device 13 (step 211) to indicate that the optic disk drive 15 is connected but no disk is contained, and no power is supplied. When the system management program or applications of the OS level L3 wants to read from the optic disk drive 15, the virtual optic-disk driver 22 reports to the request end (for example “MY COMPUTER” 31, “FILE MANAGER” 32 and other applications 33 that will access the optic disk drive) that there is no disk contained in the optic disk drive 15 (step 212). In other words, the virtual optic-disk driver 22 blocks all the access requests from the upper layer(s).

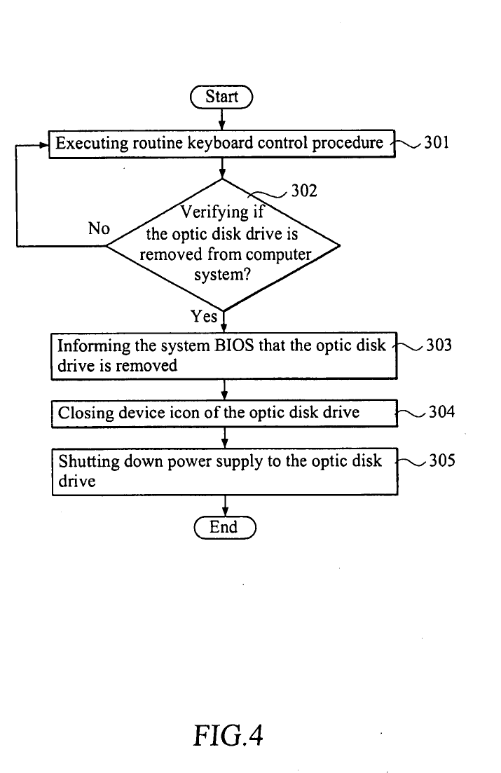

FIG. 4 shows the operation flow when the optic disk drive 15 is removed from the computer 100. At the time when the keyboard controller 14 executes the routine keyboard control procedure (step 301), if the keyboard controller 14 detects that the optic disk drive 15 is removed from the computer system (step 302), the keyboard controller 14 informs the system basic input/output system 12 to notify the user that the optic disk drive 15 is removed (step 303). The system basic input/output system 12 alerts the virtual optic-disk driver 22 or other preset hardware management program (for example “MY COMPUTER” or “FILE MANAGER”) to close the device icon of the optic disk drive 15 on the display device 13 to indicate the removal of the optic disk drive 15 (step 304). Then, the system basic input/output system 12 shuts down the power supplied to the optic disk drive 15 (step 305).

By using the above control processes, the computer system can effect optimum power management, and save power when the optic disk drive is unused.

Although the present invention has been described with reference to the best mode thereof, it is apparent to those skilled in the art that a variety of modifications and changes may be made without departing from the scope of the present invention which is intended to be defined by the appended claims.

What is claimed is:

1. An optic disk drive power management method adapted to use in a computer system for controlling power supply to an optic disk drive connected to the computer system, which comprises a central processing unit, a system basic input/output system, a keyboard controller, and an optic disk drive, the method comprising the following steps:
(a) after loading an operating system into the computer system, launching a virtual optic-disk driver;
(b) checking whether the optic disk drive includes a disk; if yes, maintaining power supply to the optic disk drive, and if not, shutting down the power supply; and
(c) at the time when the computer system serving as a request end attempts to access the optic disk drive, the system basic input/output system replying to the request end that there is no disk in the optic disk drive.

2. The method as claimed in claim 1, wherein before step (b), a step of detecting whether the optic disk drive is connected to the computer system by the keyboard controller is included.

3. The method as claimed in claim 2, wherein when the keyboard controller detects that the optic disk drive is not connected to the computer system, the keyboard controller commands, via the virtual optic-disk driver, the computer system to turn off a device icon representing the optic disk drive.

4. The method as claimed in claim 2, wherein when the keyboard controller detects that the optic disk drive is connected to the computer system, the keyboard controller commands, via the virtual optic-disk driver, the computer system to turn on a device icon representing the optic disk drive.

5. The method as claimed in claim 1, wherein in step (b), the system basic input/output system functions to determine whether there is a disk in the optic disk drive.

6. The method as claimed in claim 1, wherein after the system basic input/output system checks the optic disk drive for disks, the system basic input/output system notifies the virtual optic-disk driver to display an identifiable color or figure of the optic disk drive on the computer system.

7. The method as claimed in claim 1, wherein before step (b), a step of detecting whether an eject button is actuated with the keyboard controller is included.

8. The method as claimed in claim 7, wherein when the keyboard controller detects that the eject button is actuated, the keyboard controller notifies the system basic input/output system, and the system basic input/output system in turn sends a command of ejecting the optic disk drive to the optic disk drive.

9. The method as claimed in claim 8, wherein after the step that the system basic input/output system sends out the command of ejecting to the optic disk drive, a step of checking whether the optic disk drive is properly closed by means of the system basic input/output system is included.

10. The method as claimed in claim 9 further comprising a step of checking if a disk is present in the optic disk drive.

11. The method as claimed in claim 10, wherein if the system basic input/output system determines there is a disk is in the optic disk drive, the power supply to the optic disk drive is maintained and wherein if the system basic input/output system determines there is no disk in the optic disk drive, the power supply to the optic disk drive is shut down.

12. The method as claimed in claim 11, wherein after the system basic input/output system checks the optic disk drive for disks, the system basic input/output system notifies the virtual optic-disk driver to display an identifiable color or figure of the optic disk drive on the computer system.

13. The method as claimed in claim 1, wherein after step (c), a step of detecting whether the optic disk drive is removed from the computer system by the keyboard controller is included.

14. The method as claimed in claim 13, wherein when the keyboard controller detects that the optic disk drive is removed from the computer system, the keyboard controller notify the system basic input/output system to inform the user that the optic disk drive is removed.

15. The method as claimed in claim 13, wherein when the keyboard controller detects that the optic disk drive is removed from the computer system, the system basic input/output system shuts down the power supply to the optic disk drive.

16. The method as claimed in claim 13, wherein when the keyboard controller detects that the optic disk drive is removed from the computer system, the system basic input/output inform the virtual optic-disk driver to close a device icon representing the optic disk drive on the computer system.
